(19) United States
(12) Patent Application Publication
(10) Pub. No.: US 2024/0400931 A1
(43) Pub. Date: Dec. 5, 2024

(54) ELECTRO-RHEOLOGICAL FLUID AND CYLINDER DEVICE USING SAME

(71) Applicant: HITACHI ASTEMO, LTD., Hitachinaka-shi, Ibaraki (JP)

(72) Inventors: Satoshi ISHII, Hitachinaka-shi, Ibaraki (JP); Seogchul SHIN, Hitachinaka-shi, Ibaraki (JP); Yuichiro YAMAMOTO, Hitachinaka-shi, Ibaraki (JP); Hitomi TAKAHASHI, Hitachinaka-shi, Ibaraki (JP)

(21) Appl. No.: 18/691,260

(22) PCT Filed: Sep. 14, 2022
(86) PCT No.: PCT/JP2022/034295

§ 371 Date: Mar. 12, 2024

(30) Foreign Application Priority Data
Sep. 15, 2021 (JP) 2021-150468

(51) Int. Cl. C10M 149/14; C08G 18/08; C08G 18/32; C08G 18/48; C08G 18/66; C10N 40/08; F16F 9/53

(52) U.S. Cl. CPC C10M 149/14; C08G 18/0866; C08G 18/3206; C08G 18/4829; C08G 18/6674; F16F 9/532; C10M 2217/045; C10N 2040/08; F16F 2222/06; F16F 2224/043; F16F 2228/066

(57) ABSTRACT

Provided is an electro-rheological fluid, including: a fluid having an insulating property; and a polyether-based polyurethane particle containing a metal ion, wherein the polyurethane particle contains a chain extender, wherein the metal ion includes at least a Li ion, and wherein a ratio ([Li]/[O]) of a molar concentration ([Li]) of the Li ion to a molar concentration ([O]) of oxygen atoms of ether groups in the polyurethane particles satisfies the following condition: [Ratio of molar concentration ([Li]) of Li ion to molar concentration ([O]) of oxygen of ether groups] [Li]/[O]≥9.0×10⁻⁵.

### TECHNICAL FIELD

The present invention relates to an electro-rheological fluid and a cylinder device using the fluid.

### BACKGROUND ART

A vehicle is generally mounted with a cylinder device that damps vibration during its running in a short time period to improve its ride comfort and running stability. A shock absorber using an electro-rheological fluid (electro-rheological fluid composition) (hereinafter also referred to as “ERF”) for controlling a damping force in accordance with a road surface condition or the like has been known as one of such cylinder devices. An ERF containing particles (particle-dispersed ERF) is generally used in such cylinder device such as the shock absorber. However, it has been known that the material and shapes of the particles affect the performance of the ERF, and by extension, the performance of the cylinder device.

As a technology concerning the ERF, in, for example, Patent Literature 1, there is a disclosure of an ERF obtained by dispersing polyurethane particles each containing one or a plurality of kinds of electrolytes in a silicone oil, the ERF being characterized in that main components for forming polyurethane are a polyether polyol and toluene diisocyanate (TDI), and that each of the electrolytes in the polyurethane particles is an organic anion, such as an acetate ion or a stearate ion, and is substantially free of an anion of an inorganic metal.

In addition, in Patent Literature 2, there is a disclosure of an ERF obtained by dispersing particles each formed of an organic polymer having an ion in itself or on its surface in a nonaqueous liquid, the ERF achieving the expression of a satisfactory ER effect and the expression of a desired damping force even under low temperatures by virtue of the fact that the logarithmic value of a frequency factor in the Arrhenius equation of the density (μA/cm²) of a current flowing between electrodes through the ERF is 20 or more.

### CITATION LIST

### Patent Literature

PTL 1: JP 2015-511643 A
PTL 2: WO 2019/035330 A1

### SUMMARY OF INVENTION

### Technical Problem

In the case of the electro-rheological fluid exemplified in Patent Literature 2, the fluid using the particles each including the ion, along with the application of a voltage, the ion may migrate in each of the particles to strengthen the polarization of the particle. It has been conceived that the polarization in each of the particles enhances an electrostatic interaction between the particles, and the interaction arrays the particles in the electro-rheological fluid to result in an increase in apparent viscosity of the electro-rheological fluid, that is, the expression of an ER effect. Accordingly, an increase in amount of the ion included in each of the particles is expected to lead to an improvement in ER effect and improvements in characteristics of the fluid under low temperatures.

Meanwhile, the increase in amount of the ion is responsible for an increase in current amount at the time of voltage application because the increase enhances ionic conductivity in a system. The increase in current amount leads to an increase in energy consumption, and when the current amount reaches the upper limit of power source supply, no ER effect may be obtained because the voltage is turned off. As described above, it has been conceived that there is generally a trade-off relationship between the expression of a high ER effect and the suppression of the current amount.

In addition, when a cylinder device including the ERF is incorporated into machinery, a large current amount requires the sophistication of a power source or the like for corresponding thereto, and is disadvantageous in terms of, for example, increase in power consumption as described above.

### Solution to Problem

An object of the present invention is to provide an electro-rheological fluid (ERF), which achieves both of a high ER effect and the suppression of a current at the time of voltage application (low current density), and a cylinder device using the electro-rheological fluid, the device being typified by an electro-rheological fluid damper.

According to one aspect of the present invention, there is provided an electro-rheological fluid including: a fluid having an insulating property; and a polyether-based polyurethane particle containing a metal ion, wherein the polyurethane particle contains a chain extender, wherein the metal ion includes at least a Li ion, and wherein a ratio ([Li]/[O]) of a molar concentration ([Li]) of the Li ion to a molar concentration ([O]) of oxygen atoms of ether groups in the polyurethane particle satisfies the following condition.

[Ratio of molar concentration ([Li]) of Li ion to molar concentration ([O]) of oxygen of ether groups]

$$[ Li ] / [ O ] \geq 9.0 \times 1 {0}^{- 5}$$

In the electro-rheological fluid according to the one aspect of the present invention, the chain extender may be an aliphatic diol. In particular, the aliphatic diol may be 1,6-hexanediol. In addition, the polyurethane particle may contain, as a constituent, a trifunctional polyether polyol having three hydroxy groups, and may be formed of a thermosetting polyurethane resin.

In addition, in the electro-rheological fluid according to the one aspect of the present invention, the polyurethane particle may be a reaction product of a mixture containing a polyether polyol, an isocyanate, an emulsifying agent, and the chain extender. When the chain extender is a polyfunctional alcohol, the chain extender is used in such an amount that a molar amount of hydroxy groups of the chain extender accounts for from 15 mol % to 25 mol % of a total amount (100 mol %) of a molar amount of hydroxy groups of the polyether polyol and the molar amount of the hydroxy groups of the chain extender.

In addition, according to one aspect of the present invention, there is provided a cylinder device including the above-mentioned electro-rheological fluid. The cylinder device is, for example, a cylinder device including: a piston rod; an inner cylinder into which the piston rod is inserted; and the electro-rheological fluid arranged between the piston rod and the inner cylinder.

According to another aspect of the present invention, there is provided a cylinder device including: a piston rod; an inner cylinder into which the piston rod is inserted; and an electro-rheological fluid arranged between the piston rod and the inner cylinder, wherein the electro-rheological fluid is the above-mentioned electro-rheological fluid including: a fluid having an insulating property; and a polyether-based polyurethane particle containing a metal ion, the polyurethane particle containing a chain extender, the metal ion including at least a Li ion.

In addition, in the electro-rheological fluid, the formulation of the chain extender and the Li ion may be such formulation that no change in damping force with temperature occurs, for example, such formulation that a change in damping force due to a temperature change is less than 10%.

According to one embodiment of the present invention, there can be provided the electro-rheological fluid that achieves both of a high ER effect and a low current density. In addition, there can be provided the cylinder device such as an electro-rheological fluid damper, the device using the electro-rheological fluid to increase the width by which a damping force can be changed by an improvement in ER effect, to thereby achieve device simplification by a reduction in applied voltage and a cost reduction along with the simplification.

### BRIEF DESCRIPTION OF DRAWINGS

FIG. 1 is a view for illustrating an example of the production flowchart (outline) of an electro-rheological fluid according to the present invention.

FIG. 2 is a schematic view for illustrating the structure of an electro-rheological fluid damper according to one embodiment of the present invention.

FIG. 3 is a graph for showing a relationship between the ratio “[Li]/[O]” of an electro-rheological fluid prepared in each of Examples and the value of the ER effect thereof.

FIG. 4 is a graph for showing a relationship between the ratio “[Li]/[O]” of the electro-rheological fluid produced in each of Examples and the current density thereof at the time of voltage application.

FIG. 5 is a graph for showing a relationship between the ratio “[Li]/[O]” of the electro-rheological fluid produced in each of Examples and the ratio (ER effect/current density) of the ER effect thereof to the current density thereof.

FIG. 6 is a graph for showing a relationship between the ratio “[Li]/[O]” of the electro-rheological fluid produced in each of Examples and a damping force (N) when a voltage of 5 kV is applied to an electro-rheological fluid damper.

FIG. 7 is a graph for showing a relationship between the ratio “[Li]/[O]” of the electro-rheological fluid produced in each of Examples and the ratio (50° C./30° C.) of a damping force at 50° C. to a damping force at 30° C. when a voltage of 5 kV is applied to the electro-rheological fluid damper.

### DESCRIPTION OF EMBODIMENTS

An electro-rheological fluid of the present invention has an aspect in which polyurethane particles are dispersed in a fluid having an insulating property (electrical insulation medium).

The inventors of the present invention have considered the application of a chain extender that is an additive accelerating the phase separation (separation between the soft segment and hard segment) of polyurethane for achieving the above-mentioned object, that is, an improvement in ER effect and the suppression of a current at the time of voltage application (low current density) in the electro-rheological fluid, which are effects apparently contrary to each other. Details are described below.

When the chain extender is used at the time of the production of a polyurethane particle including a polyol and a diisocyanate, the polyol forms the soft segment of a polymer and the diisocyanate reacts with the chain extender to form the hard segment thereof, and hence the polyol and the diisocyanate undergo phase separation. The microphase-separated structure accelerates the separation of the functions of the polyurethane particle, that is, separates the particle into the soft segment responsible for ionic conductivity and flexibility, and the hard segment responsible for heat resistance and mechanical strength.

Herein, the polyurethane particle(s) according to the present invention is a polyether-based polyurethane particle(s), and an ion largely contributing to the expression of the above-mentioned ER effect is a Li ion that is a metal ion. Through the molecular motion of a polyurethane chain, the Li ion is repeatedly bonded to and dissociated from the oxygen atoms of ether groups present in a system to migrate toward the direction in which a voltage is applied. At this time, as the amount of the Li ion increases, the frequency of the migration of the Li ion increases. That is, as the ratio ([Li]/[O]) of the Li ion to the oxygen atoms of the ether groups becomes larger, the ionic conductivity is improved.

In the present invention, the following has been considered: the ratio “[Li]/[O]” of the molar concentration ([Li]) of the Li ion to the molar concentration ([O]) of oxygen of the ether groups is increased to improve the ionic conductivity even when the [Li] amount remains unchanged, and to improve the ER effect. In addition, the following attempt has been made: the above-mentioned chain extender is applied to cause the phase separation of the polyurethane particle(s), and by extension, to accelerate function separation between the soft segment and the hard segment, which have been subjected to the phase separation, to thereby cause the soft segment (polyol portion) of the polyurethane particle(s) to be efficiently responsible for the migration of the Li ion. The foregoing means that efficient utilization of the oxygen atoms [O] of the ether groups in the ionic conductivity is induced to enable a reduction in ratio of the soft segment in material composition for forming each of the polyurethane particle(s).

As described above, in the present invention, the chain extender is applied to increase the ratio “[Li]/[O]” and to achieve efficient ionic conduction in the electro-rheological fluid, and the increased ratio and the conduction are advantageous for an improvement in ER effect. At the same time, the entirety of the polyurethane particle(s) hardens through a reduction in ratio of the soft segments, and hence an increase in current can be suppressed. Thus, the inventors of the present invention have achieved both of a high ER effect and a low current in the electro-rheological fluid, and by extension, have achieved both of a high damping force and a low current.

In addition, with regard to the damping force of a cylinder device such as a damper, the inventors of the present invention have recognized the following: even in an ERF that expresses a sufficient damping characteristic at room temperature (30° C.), when the ratio “[Li]/[O]” is equal to or less than a certain value, for example, its particles adhere to an electrode to form a layer or aggregate to stick thereto, and hence the damping force reduces under a high temperature (50° C.), that is, the damping force fluctuates with temperature.

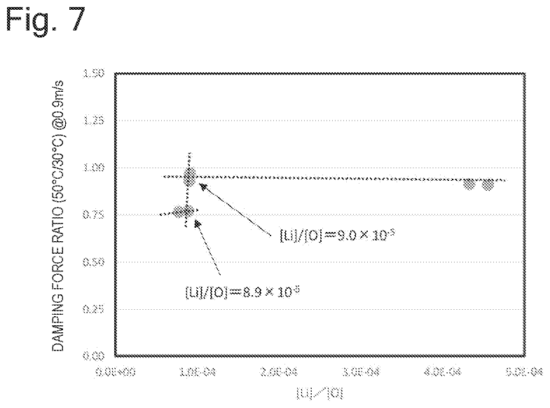

More specifically, in the results of the measurement of a damping force with an electro-rheological fluid damper to be described later, the following result was obtained (FIG. 7): although a damping force ratio (50° C./30° C.) was substantially constant when the ratio “[Li]/[O]” was equal to or more than a certain value, when the ratio “[Li]/[O]” became equal to or less than 8.9×10⁻⁵, the above-mentioned ratio largely fluctuated, and hence a damping force at 50° C. reduced by as large as about 25% as compared to that at 30° C. In view of the result, the inventors of the present invention have found, as a range in which a fluctuation in damping force with temperature is small (a change in damping force is less than 10%), a condition that the ratio “[Li]/[O]” in the electro-rheological fluid be set to 9.0×10⁻⁵ or more, and have blended the chain extender and the Li ion so that the condition can be achieved.

As described above, the inventors have investigated the formulation of the chain extender and the Li ion in an ERF, which satisfies characteristics as a fluid and is virtually free from being affected by temperatures even in terms of damping force of a damper, and have completed the present invention.

The respective constituents of the electro-rheological fluid according to the present invention and an electro-rheological fluid damper serving as an example of a cylinder device using the electro-rheological fluid are described in detail below.

### [Fluid Having Insulating Property]

Examples of the fluid having an insulating property to be used in the electro-rheological fluid of the present invention include electrical insulation media including: liquid hydrocarbons, such as paraffins (e.g., n-nonane), olefins (e.g., 1-nonene and (cis or trans)-4-nonene), and aromatic hydrocarbons (e.g., xylene); and silicone oils, such as a polydimethylsiloxane and a liquid methylphenylsiloxane each having a viscosity of from 3 mPa-s to 300 mPa-s. A silicone oil is preferably used as the fluid having an insulating property (hereinafter also referred to as “electrical insulation medium”). The electrical insulation medium may be used alone or in combination with any other electrical insulation medium. The freezing point of the electrical insulation medium is preferably less than −40° C., and the boiling point thereof is preferably 150° C. or more.

### [Polyurethane Particle(s)]

The polyurethane particle(s) according to the present invention is a polyether-based polyurethane particle(s) containing a metal ion, and the polyurethane particle(s) contains the chain extender.

The incorporation of the metal ion into the polyurethane particle(s) may adopt any one of a mode in which the metal ion is included in the particle or a mode in which the metal ion adheres to the surface of the particle.

The polyurethane particle(s) may be, for example, a reaction product of a mixture containing a polyol, an isocyanate, an emulsifying agent, and the chain extender.

In addition, the amount of the polyurethane particle(s) in the electro-rheological fluid may be set to, for example, from 30 mass % to 70 mass % on the basis of the total mass of the electro-rheological fluid.

### <Polyol>

Examples of the polyol to be generally used in the production of polyurethane include a polyether polyol, a polyester polyol, and a polymer polyol. In the present invention, polyether-based polyurethane particle(s) is adopted as the polyurethane particle(s), that is, a polyether polyol is adopted as the polyol.

Examples of the polyether polyol include polyether polyols each obtained by adding one kind or two or more kinds of ethylene oxide, propylene oxide, butylene oxide, and styrene oxide to ethylene glycol, diethylene glycol, propylene glycol, 1,4-butylene glycol, dihydroxydiphenylpropane, glycerin, hexanetriol, trimethylolpropane, pentaerythritol, sorbitol, sucrose, dipropylene glycol, dihydroxydiphenylmethane, dihydroxydiphenyl ether, dihydroxybiphenyl, hydroquinone, resorcin, naphthalenediol, aminophenol, aminonaphthol, a phenol formaldehyde condensate, phloroglucin, methyldiethanolamine, ethyldiisopropanolamine, triethanolamine, ethylenediamine, hexamethylenediamine, bis(p-aminocyclohexane), tolylenediamine, diphenylmethanediamine, or naphthalenediamine.

Of those, a trifunctional polyether polyol having three hydroxy groups (—OH) may be preferably used.

### <Isocyanate>

Examples of the isocyanate include toluene diisocyanate (TDI), diphenylmethane diisocyanate (MDI), polymeric MDI (pMDI), tolidine diisocyanate, naphthalene diisocyanate (NDI), xylylene diisocyanate (XDI), tetramethyl-m-xylylene diisocyanate, and dimethylbiphenyl diisocyanate (BPDI), hexamethylene diisocyanate (HDI), isophorone diisocyanate (IPDI), hydrogenated xylylene diisocyanate, and dicyclohexylmethane diisocyanate. Further, an adduct, an isocyanurate, a biuret, a uretdione, and a blocked isocyanate, which are modified isocyanates, may be used. The modified isocyanates include TDI-based, MDI-based, HDI-based, and IPDI-based modified isocyanates, and the respective modified isocyanates include the respective modified products. The number of the kinds of the isocyanates is not limited to one, and two or more kinds thereof may be used in combination.

The polyol and the isocyanate are desirably used so that the molar ratio [(NCO group)/(OH group)] of the isocyanate group (NCO group) of the isocyanate to the hydroxy group (OH group) of the polyol may become from 1 to 1.5.

When the isocyanate that is a curing agent is used in an amount slightly in excess of the equivalent of the polyol, moisture in a reaction system is consumed by a reaction between the isocyanate group of the curing agent and water. Thus, the effect by which the moisture is removed from the electro-rheological fluid is improved to lead to the suppression of an increase in current amount due to the residual moisture.

### <Emulsifying Agent>

Although the above-mentioned emulsifying agent (surfactant) is not particularly limited, the emulsifying agent may be, for example, an amino-modified polysiloxane in view of, for example, an affinity for the silicone oil serving as the above-mentioned electrical insulation medium.

An example of the amino-modified polysiloxane may be a polysiloxane having an alkoxy group in a side chain and/or at a terminal thereof.

An example thereof may be a polysiloxane represented by the following formula.

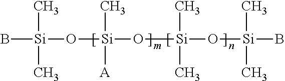

In the formula, A represents an aminoalkyl group, such as an aminoethyl group (—(CH₂)₂NH₂), an aminopropyl group (—(CH₂)₃NH₂), or an aminoethylaminopropyl group (—(CH₂)₃NH(CH₂)₂NH₂).

B represents an alkoxy group, such as a methoxy group (CH₃O—) or an ethoxy group (C₂H₅O—).

Examples of commercial products of the polysiloxane having an alkoxy group (emulsifying agent) may include reactive silicone oils (product names: KF-857, KF-8001, KF-862, and KF-858) each manufactured by Shin-Etsu Silicone.

In addition, examples of commercial products of the amino-modified polysiloxane (emulsifying agent) except the foregoing may include a polysiloxane (product name: SF1706) and polydimethylsiloxanes (product names: OF7747, TP3635, 89893 (SE4029), and 81904LT) each manufactured by Momentive Performance Materials Japan LLC.

The above-mentioned emulsifying agents may be used alone or in combination thereof.

The above-mentioned emulsifying agent is preferably blended at a ratio of from 1 mass % to 2.0 mass % or at a ratio of from 1 mass % to 1.5 mass % with respect to the mass of the above-mentioned electrical insulation medium. When the blending amount of the emulsifying agent is set to 1 mass % or more with respect to the mass of the electrical insulation medium, a sufficient dispersed state is secured. In addition, when the amount is set to 2.0 mass % or less, the particle diameter of the polyurethane particle(s) can be controlled within a suitable range, and hence the characteristics of the electro-rheological fluid can be made suitable.

### <Other Emulsifying Agent>

In addition, in the present invention, any other emulsifying agent except the foregoing may be used in combination to the extent that the effects of the present invention are not impaired.

Examples of the other emulsifying agent include surfactants that are each soluble in the above-mentioned electrical insulation medium, and are each derived from an amine, an imidazoline, an oxazoline, an alcohol, a glycol, or a sorbitol.

A polymer soluble in the above-mentioned electrical insulation medium may also be used, and may be, for example, a polymer containing 0.1 mass % to 10 mass % of N (nitrogen atom) and/or OH (hydroxy group), containing 25 mass % to 83 mass % of a C₄₋₂₄ alkyl group, and having a weight-average molecular weight of from 5,000 to 1,000,000. Examples of N- and OH-functional compounds in such polymer may include an amine, an amide, an imide, a nitrile, a 5- or 6-membered N-containing heterocycle, or an alcohol, and a C₄₋₂₄ alkyl ester of acrylic acid or methacrylic acid. Examples of the N- and OH-functional compounds include N,N-dimethylaminoethyl methacrylate, tert-butylacrylamide, maleimide, acrylonitrile, N-vinylpyrrolidone, vinylpyridine, and 2-hydroxyethyl methacrylate. The polymer emulsifying agent has an advantage in that a system prepared by using the emulsifying agent is generally more stable in terms of sedimentation dynamics than a system prepared by using a low-molecular weight surfactant.

A modified silicone oil, such as an amino-modified silicone or a fluorine-modified silicone, may also be used.

### <Chain Extender>

A low-molecular weight polyfunctional alcohol, a low-molecular weight polyfunctional amine, or the like is used as the chain extender. Examples of the polyfunctional alcohol include 1,3-propanediol, 1,4-butanediol, 1,5-pentanediol, 1,6-hexanediol, 1,7-heptanediol, 1,8-octanediol, 1,9-nonanediol, 1,4-cyclohexamnethylenedimethanol, hydroquinone di(2-hydroxyethyl ether), glycerin, 1,1,1-trimethylolpropane, 1,2,4-butanetriol, 1,2,5-pentanetriol, 1,2,6-hexanetriol, 1,1,33-propanetetraol, 1,2,3,4-butanetetraol, 1,1,5,5-pentanetetraol, and 1,2,3,5-pentanetetraol.

Examples of the polyfunctional amine include 1,3-propanediamine, 1,4-butanediamine, 1,5-pentanediamine, 1,6-hexanediamine, 1,7-heptanediamine, 1,8-octanediamine, 1,9-nonanediamine, dimethylthiotoluenediamine, 4,4-methylenebis-o-chloroaniline, isophoronediamine, piperazine, 1,2,3-propanetriamine, 1,2,4-butanetriamine, 1,2,5-pentanetriamine, 1,2,6-hexanetriamine, 1,1,3,3-propaneteiraamine, 1,2,3,4-butanetetraamine, 1,1,5,5-pentanetetraamine, and 1,2,3,5-pentanetetraamine.

The number of the kinds of the chain extenders is not limited to one, and two or more kinds thereof may be used in combination. For example, a bifunctional chain extender and a chain extender that is trifunctional or more may be used in combination. In addition, the chain extender is not limited to the polyfunctional alcohol and the polyfunctional amine described above. Further, of those, an aliphatic diol is preferred. In particular, 1,4-butanediol, 1,5-pentanediol, or 1,6-hexanediol is suitable because there is an advantage in that such diol has high versatility and a low melting point and hence makes the process simpler.

For example, when the chain extender is a polyfunctional alcohol such as an aliphatic diol, the chain extender may be used in such an amount that the molar amount of the hydroxy groups of the chain extender accounts for, for example, from 15 mmol % to 25 mmol % of the total amount (100 mol %) of the molar amount of the hydroxy groups (OH groups) of the polyol and the molar amount of the hydroxy groups of the chain extender. In addition, when the chain extender is a poly functional amine, the chain extender may be used in such an amount that as in the foregoing, the molar amount of the amino groups of the chain extender accounts for from 15 mol % to 25 mol % of the total amount (100 mol %) of the molar amount of the hydroxy groups (OH groups) of the polyol and the molar amount of the amino groups of the chain extender.

### <Metal Ion: Lithium Ion>

The polyurethane particle(s) according to the present invention contains the metal ion in itself. The incorporation of the metal ion may be a form in which the metal ion is in the state of being dissolved or dispersed in the particle(s), or of not being dispersed (of being unevenly distributed) therein, that is, the ion is included in the particle, or the incorporation may be a mode in which the ion adheres to the surface of the particle. In the electro-rheological fluid of the present invention, a metal ion in the state of being dissolved or dispersed in the electrical insulation medium, or of not being dispersed (of being unevenly distributed) therein may be present.

Examples of the metal ion include ions of metal elements, such as lithium, zinc, chromium, copper, nickel, cobalt, iron, manganese, and tungsten, and in the present invention, a lithium ion is incorporated as an essential constituent. Supply sources for those metal ions may be, for example, salts of the metal elements such as halides.

In addition, in the present invention, the lithium ion is used so that the ratio “[Li]/[O]” of the molar concentration [Li] of the lithium ion to the molar concentration [O] of the oxygen atoms of ether groups in the polyurethane particle(s) may become 9.0×10⁻⁵ or more.

The setting of the ratio “[Li]/[O]” within a predetermined range can be expected to improve ionic conductivity in an electro-rheological fluid to be obtained, and by extension, a damping force therein, and to suppress a current value therein at the time of voltage application.

### <Particle Diameter of Polyurethane Particle(s)>

The polyurethane particle(s) according to the present invention may be a particle(s) having an average particle diameter of, for example, from about 2 μm to about 5 μm. The setting of the particle diameters of the polyurethane particle(s) within the above-mentioned numerical range can be expected to achieve both of an electro-rheological effect and their dispersibility, and can be expected to prevent their sedimentation and the deterioration of their redispersibility.

### <Method of Producing Electro-Rheological Fluid>

The electro-rheological fluid of the present invention may be produced by, for example, dispersing and emulsifying a mixture containing the electrical insulation medium, the polyol, the metal ion, the emulsifying agent, and the chain extender described above, and any other additive (e.g., a catalyst for polyurethane synthesis) to be used as desired, and adding the isocyanate that is a curing agent thereto.

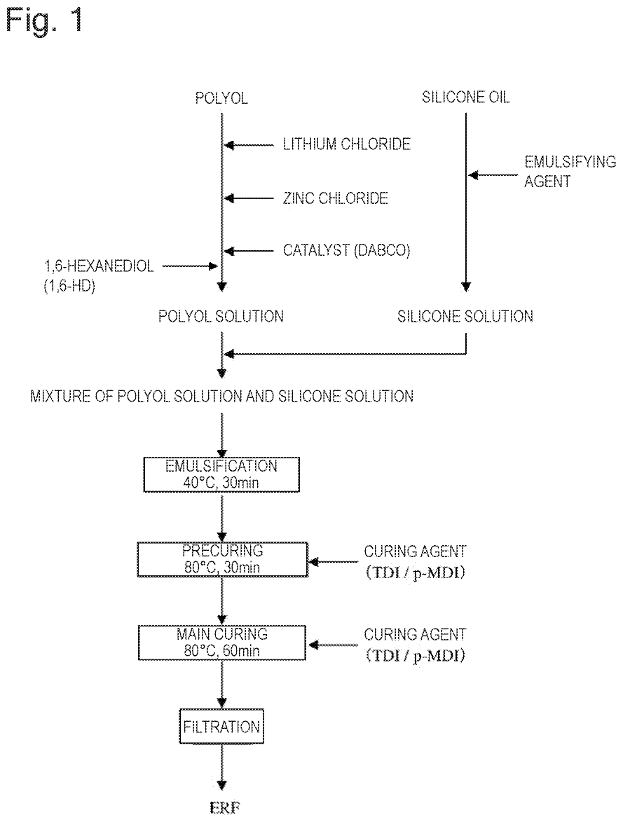

An example of a method of preparing the electro-rheological fluid of the present invention is described below with reference to a production flowchart (outline) illustrated in FIG. 1. Specific names of the respective components illustrated in FIG. 1 and conditions such as temperatures in the respective steps therein are merely examples, and it is not intended that the present invention be limited to such description.

### 1. Weighing and Dissolution Step

This step is a step of separately preparing a solution (represented by “POLYOL SOLUTION” in FIG. 1) containing the polyol, the metal ion, the chain extender, and the like, and a solution (represented by “SILICONE SOLUTION” in FIG. 1) containing the electrical insulation medium (e.g., a silicone oil) and the emulsifying agent.

The prepared polyol solution and silicone solution are individually stored at room temperature, and are mixed in the next step (emulsification).

The preparation of each of the solutions is described below.

### 1-1. Preparation of Polyol Solution

The polyol, the metal ion, and the chain extender are each weighed, and are added to a mixing bottle (e.g., a bottle with a stopper) or to a glass beaker or flask having a proper size, followed by the mixing and dissolution of the respective materials with a stirring device, such as a magnetic stirrer and a magnet stirring bar, or a homogenizer, by warm stirring.

An example of a specific operation procedure is described below. The following operations may be performed in a glove box as required.

First, the polyol is weighed in the bottle with a stopper.

The metal ion may be prepared as a salt of the above-mentioned metal element such as a halide or preferably a chloride, and in the present invention, lithium chloride may be preferably used as a generating source for a lithium ion. In addition, for example, a zinc ion may be used as a metal ion in addition to the lithium ion, and zinc chloride may be preferably used as a generating source therefor.

Accordingly, lithium chloride, zinc chloride, the chain extender (e.g., 1,6-hexanediol), and the catalyst for polyurethane synthesis are each preferably weighed.

Next, the polyol is stirred while being heated to, for example, from 50° C. to 80° C., and it is recognized that its temperature has reached a desired temperature, After that, metal element salts are sequentially added as metal ion species thereto. In the case where a plurality of kinds of metal ions are used, for example, in the case where lithium chloride and zinc chloride are used, lithium chloride is first added to the polyol. While the above-mentioned desired temperature is maintained, lithium chloride is mixed into the polyol under stirring, and the materials are stirred and dissolved until undissolved matter, a precipitate, or the like cannot be visually observed from the appearance of the mixture. Next, zinc chloride is added, and while the above-mentioned desired temperature is maintained, the materials are mixed and stirred. The materials are stirred and dissolved until undissolved matter, a precipitate, or the like cannot be visually observed from the appearance of the mixture. The catalyst for polyurethane synthesis is added after the dissolution of the metal element salts, and while the above-mentioned desired temperature is maintained, the materials are mixed and stirred. Finally, 1,6-hexanediol (chain extender) is added, and while the above-mentioned desired temperature is maintained, the materials are mixed and stirred. Thus, the polyol solution containing the metal ion, the chain extender, and the catalyst for polyurethane synthesis is obtained.

A stirring time may be appropriately set so that undissolved matter or a precipitate may not be observed in the generating source for the metal ion, and the respective components may be dissolved or dispersed. For example, the entire stirring time may be set to 8 hours or more.

As described in the above-mentioned specific operation procedure, when two or more kinds of metal element salts are used as generating sources for metal ions, the salts are preferably dissolved in a stepwise manner. That is, for example, the following operation is preferably performed: after one kind of metal element salt has been added and completely dissolved, the next one kind of metal element salt is added and completely dissolved.

In the present invention, the usage amount of the above-mentioned metal element salt may be adjusted so that for the lithium ion, the ratio “[Li]/[O]” of the molar concentration [Li] of the lithium ion to the molar concentration [O] of the oxygen atoms of ether groups in the polyurethane particle(s) may fall within the range of 9.0×10⁻⁵ or more.

The metal ion may be blended in such an amount that the total amount thereof finally becomes generally, for example, 0.01 ppm or more and 1,500.00 ppm or less with respect to the total amount (electro-rheological fluid) of the polyurethane particle(s) and the electrical insulation medium.

In addition, in the present invention, when the above-mentioned chain extender is a polyfunctional alcohol such as an aliphatic diol, the chain extender may be preferably used in such an amount that the molar amount of the hydroxy groups of the chain extender accounts for, for example, from 15 mol % to 25 mol % of the total amount (100 mol %) of the molar amount of the hydroxy groups (01H groups) of the polyol and the molar amount of the hydroxy groups of the chain extender.

When the catalyst for polyurethane synthesis is used, as described in the above-mentioned specific operation procedure, the catalyst is preferably added to a system after the complete dissolution of the metal ion (i.e., the metal element salt).

Examples of the catalyst may include amine-based catalysts, and specific examples thereof include triethylamine, benzyldiethylamine, 1,4-diazabicyclo[2,2,2]octane (DABCO), 1,8-diazabicyclo[5,4,0]undecene, N,N,N′,N′-tetramethyl-1,3-butanediamine, and N-ethylmorpholine. When the catalyst is used, the catalyst may be blended at a ratio of up to about 0.2 mass % with respect to the amount of polyurethane to be finally obtained. However, attention needs to be paid because the addition of a large amount of the catalyst may cause a decomposition reaction by the catalyst.

### 1-2. Preparation of Silicone Solution

The silicone oil (electrical insulation medium) and the emulsifying agent are weighed, and are added to a mixing bottle (e.g., a bottle with a stopper) or to a glass beaker or flask having a proper size, followed by the mixing of the respective materials at normal temperature through use of a stirring device, such as a magnetic stirrer and a magnet stirring bar, or a homogenizer, as required.

An example of a specific operation procedure is described below.

First, the silicone oil (electrical insulation medium) is weighed in the bottle with a stopper. Meanwhile, the emulsifying agent is weighed, and is added to and mixed in the silicone oil to provide the silicone solution.

The above-mentioned emulsifying agent may be added in an amount corresponding to from 1.0 mass % to 2.0 mass % of the usage amount of the silicone oil (electrical insulation medium).

During the above-mentioned mixing and dissolution, a temperature at the time of stirring may be set to normal temperature (20° C.±10° C.).

### 2. Synthesis Preparation Step

This step is a step of preparing the curing agent to be used in “4. Precuring Step” and “5. Main Curing Step” to be described later, that is, the isocyanate (not shown). The above-mentioned isocyanates that are curing agents may be used in combination thereof. For example, toluene diisocyanate (TDI) and polymethylene polyphenyl polyisocyanate (p-MDI) may be used in combination.

The isocyanate is weighed in a bottle with a stopper. When two or more kinds of isocyanates are used, another kind of isocyanate may be added thereto to provide a mixed liquid.

The curing agent (isocyanate) thus weighed and prepared is used in a divided manner in the two steps to be described later, that is, “4. Precuring Step” and “5. Main Curing Step.” Accordingly, for example, the following may be performed: an amount corresponding to from 10% to 20% of the curing agent is secured in advance as a portion to be used in “4. Precuring Step,” and the residue is separately secured as a portion to be used in “5. Main Curing Step.”

### 3. Emulsification Step

This step is a step of dispersing and mixing the polyol solution and the silicone solution obtained in “Preparation Step(s)” of 1, described above with a stirring device or a disperser such as a homogenizer to provide the mixture of the polyol solution and the silicone solution, followed by the emulsification of the mixture to provide an emulsion in which the polyol is dispersed in the silicone oil (electrical insulation medium). The average particle diameter of the polyurethane particle(s) to be formed in a subsequent step may be adjusted by, for example, the kind of the stirring device or the disperser to be used in this step, and the kind, number of revolutions (speed), and stirring (revolution) time of a shear blade in the disperser.

An example of a specific operation procedure is described below.

First, the polyol solution obtained in the step 1-1, is weighed in a flask, and the silicone solution obtained in the step 1-2, is weighed and added thereto.

The flask is set in a thermostat such as a water bath, and the solutions are stirred and mixed with a homogenizer to provide the emulsion.

During the above-mentioned stirring and mixing, the number of revolutions at the time of the stirring may be set to from about 10,000 rpm to about 20,000 rpm, a temperature at the time of the stirring may be set to, for example, around 40° C. and a stirring time may be set to about 0.5 hour. However, the present invention is not limited to those conditions.

### 4. Precuring (Curing Agent Addition (1)) Step

This step is a step of curing the emulsion (emulsion particles in an uncured state) produced in “3. Emulsification Step” described above to provide semi-cured polyurethane particle(s). In this step, an amount corresponding to from about 10% to about 20% of the total amount of the curing agent (isocyanate) to be used for forming the polyurethane particle(s) is used.

An example of a specific operation procedure is described below.

While, for example, the same stirring (e.g., stirring and mixing with the homogenizer) as that in “3. Emulsification Step” described above is continued, the curing agent (isocyanate) is added dropwise in an amount corresponding to from about 10% to about 20% of its total addition amount to the emulsion prepared in “3. Emulsification Step” described above with a tube pump or the like.

During the addition of the above-mentioned curing agent, the following may be performed: the emulsion is set in a thermostat such as a mantle heater so as to have a predetermined temperature (e.g., 50° C. or more), and the stirring is continued; and after the predetermined temperature has been reached, (part of) the curing agent is added. In addition, a stirring time may be set to about 0.5 hour, but the present invention is not limited to such addition and stirring conditions. At the initial stage of the loading of the curing agent, several droplets thereof may be dropped (about five times) for recognizing that the stirring is not stopped.

### 5. Main Curing (Curing Agent Addition (2)) Step

This step is a step of further curing the semi-cured polyurethane particle(s) (emulsion particle(s)) formed by “4. Precuring Step” described above. In this step, an amount remaining after the consumption in the preceding step out of the total amount of the curing agent (isocyanate) to be used for forming the polyurethane particle(s), that is, an amount corresponding to from 80% to 90% of the total amount is used.

An example of a specific operation procedure is described below.

After the completion of the operations of “4. Precuring Step” described above, the remaining amount of the curing agent (isocyanate), that is, the amount corresponding to from 80% to 90% of the total amount is added dropwise to the emulsion of the semi-cured polyurethane particle(s), which is stored in a container (e.g., a flask) under a stirring state, with a tube pump or the like while the stirring is continued.

During the addition of the above-mentioned remaining curing agent, the following may be performed for preventing an excessive increase in temperature by heat of reaction (isocyanate reaction): the stirring is continued while the temperature of the semi-cured emulsion is adjusted so as to be a predetermined temperature (e.g., 80° C. or less); and after the predetermined temperature has been reached, the remaining curing agent is added. In addition, a stirring time may be set to about 1.0 hour, but the present invention is not limited to such addition and stirring conditions. After the addition and the stirring, the liquid temperature is reduced to about 70° C., and then a stirring device (e.g., a homogenizer) is stopped. Thus, a fluid that can be said to be a crude product can be obtained.

### 6. Filtration Step

After the completion of the operations of “5. Main Curing Step,” the resultant fluid is filtered to provide an electro-rheological fluid (represented by “ERF” in the figure). Herein, the filtration treatment may be performed in two stages for preventing the fluid from scattering to a container inner wall, and removing dry waste and impurities.

### [Cylinder Device]

The present invention is directed to a cylinder device including the electro-rheological fluid.

More specifically, the present invention is directed to a cylinder device including: a piston rod; an inner cylinder into which the piston rod is inserted; and the electro-rheological fluid arranged between the piston rod and the inner cylinder.

An electro-rheological fluid damper, which is a damping force-adjustable shock absorber using the electro-rheological fluid as a working fluid, is described below as an example of the cylinder device. A preferred embodiment of the electro-rheological fluid damper is described in detail with reference to the attached drawings. However, the following embodiment is not intended to limit the cylinder device to which the present invention is directed, and the electro-rheological fluid damper serving as an example thereof.

### <Electro-Rheological Fluid Damper>

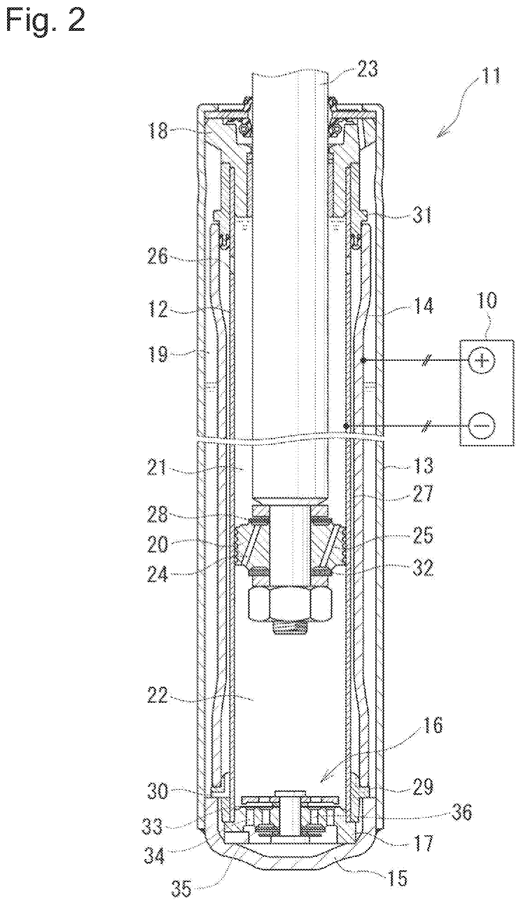

FIG. 2 is a sectional view taken along a plane including the axis of an electro-rheological fluid damper 11 of a preferred embodiment according to the present invention.

When reference is made to FIG. 2, the electro-rheological fluid damper 11 includes an inner cylinder 12 (cylinder), an outer cylinder 13, and an intermediate cylinder 14. For convenience, a vertical direction in FIG. 2 is defined as a vertical direction in the electro-rheological fluid damper 11.

The lower end portion of the outer cylinder 13 is closed with a bottom cap 15. The lower end portion of the inner cylinder 12 is fitted into the valve body 17 of a bottom valve 16, and the upper end portion thereof is fitted into a rod guide 18. A cyclic reservoir chamber 19 is formed between the inner cylinder 12 and the outer cylinder 13. The electro-rheological fluid according to the present invention and a gas are sealed in the reservoir chamber 19. The gas in the reservoir chamber 19 is, for example, a nitrogen gas or air.

A piston 20 is slidably arranged inside the inner cylinder 12. The lower end portion of a piston rod 23 is connected to the piston 20, The upper end portion of the piston rod 23 extends to the outside of the outer cylinder 13 through the rod guide 18. The piston 20 partitions the inside of the inner cylinder 12 into two chambers, that is, a cylinder upper chamber 21 and a cylinder lower chamber 22. The piston 20 has arranged therein a compression-side passage 24 and an extension-side passage 25 that communicate the cylinder upper chamber 21 and the cylinder lower chamber 22 to each other.

Herein, the electro-rheological fluid damper 11 forms a uniflow structure, and a double-cylinder uniflow structure is illustrated as an example thereof. Although the electro-rheological fluid damper may be a biflow structure or a single-cylinder type, a case in which the electro-rheological fluid damper 11 has a uniflow structure is described below in accordance with FIG. 2.

That is, the electro-rheological fluid damper 11 causes the electro-rheological fluid to flow from the cylinder upper chamber 21 to a cyclic flow path 27 formed between the inner cylinder 12 and the intermediate cylinder 14 through a passage 26 arranged in the inner cylinder 12 in both the compression stroke and extension stroke of the piston rod 23. To form the uniflow structure, a compression-side check valve 28 is arranged on the upper end surface of the piston 20, and a disc valve 32 is arranged on the lower end surface of the piston 20.

The compression-side check valve 28 is opened at the time of the compression stroke of the piston rod 23 to allow the flow of the electro-rheological fluid from the cylinder lower chamber 22 to the cylinder upper chamber 21 through the compression-side passage 24. Meanwhile, when a pressure in the cylinder upper chamber 21 reaches a predetermined pressure at the time of the extension stroke of the piston rod 23, the disc valve 32 is opened to relieve the pressure in the cylinder upper chamber 21 to the cylinder lower chamber 22 through the extension-side passage 25.

When reference is made to FIG. 2, the valve body 17 partitions the reservoir chamber 19 and the cylinder lower chamber 22 from each other. A cyclic holding member 29 is fitted onto the outer periphery of the inner cylinder 12 fitted into the small-diameter portion of the valve body 17. The holding member 29 positions the lower end portion of the intermediate cylinder 14 in the axial direction (vertical direction) and a radial direction. The holding member 29 is formed of an electrically insulating material, and electrically insulates the inner cylinder 12, the bottom cap 15, and the valve body 17 from the intermediate cylinder 14, The holding member 29 has formed therein a passage 30 that communicates the cyclic flow path 27 formed between the inner cylinder 12 and the intermediate cylinder 14 to the reservoir chamber 19.

In addition, a check valve 33 is opened at the time of the extension stroke of the piston rod 23 to allow the flow of the electro-rheological fluid from the reservoir chamber 19 to the cylinder lower chamber 22 through an extension-side passage 34. Meanwhile, when a pressure in the cylinder lower chamber 22 reaches a predetermined pressure at the time of the compression stroke of the piston rod 23, a disc valve (relief valve) 35 is opened to relieve the pressure in the cylinder lower chamber 22 to the reservoir chamber 19 through a compression-side passage 36.

Meanwhile, the intermediate cylinder 14 is formed of a conductive material. The upper end portion of the intermediate cylinder 14 is positioned in the radial direction by the rod guide 18 through a holding member 31 fitted onto the outer peripheral surface of the upper end portion of the inner cylinder 12. The holding member 31 is formed of an electrically insulating material, and electrically insulates the intermediate cylinder 14 from the inner cylinder 12. In addition, the intermediate cylinder 14 is connected to the positive electrode of a battery (not shown) through a high-voltage driver (voltage-generating portion, not shown). That is, the intermediate cylinder 14 forms a positive electrode that applies an electric field (voltage) to the electro-rheological fluid flowing in the flow path 27, Meanwhile, the inner cylinder 12 to be used as a negative electrode (ground electrode) is connected to the ground through the valve body 17, the bottom cap 15, the outer cylinder 13, and a high-voltage driver 10.

With such configuration, at the time of the extension stroke of the piston rod 23, the compression-side check valve 28 is closed by the movement of the piston 20 in the inner cylinder 12 to pressurize the electro-rheological fluid in the cylinder upper chamber 21. The fluid flows to the cyclic flow path 27 through the passage 26, and flows into the reservoir chamber 19 through the passage 30. At this time, the electro-rheological fluid whose amount corresponds to the movement of the piston 20 opens the check valve 33 of the valve body 17 from the reservoir chamber 19 to flow into the cylinder lower chamber 22.

Meanwhile, at the time of the compression stroke of the piston rod 23, the compression-side check valve 28 of the piston 20 is opened and the check valve 33 of the valve body 17 is closed by the movement of the piston 20 in the inner cylinder 12. Thus, while the electro-rheological fluid in the cylinder lower chamber 22 flows into the cylinder upper chamber 21, the electro-rheological fluid whose amount corresponds to the entry of the piston rod 23 into the inner cylinder 12 flows to the cyclic flow path 27 through the passage 26, and flows into the reservoir chamber 19 through the passage 30.

Thus, the electro-rheological fluid flows in the cyclic flow path 27 in both the extension and compression strokes of the piston rod 23, and hence the electro-rheological fluid damper 11 generates a damping force in accordance with its viscosity. At this tire, the viscosity of the electro-rheological fluid changes with a potential difference between the inner cylinder 12 (ground electrode) and the intermediate cylinder 14 (positive electrode), and hence the damping force can be adjusted by changing an applied voltage.

In FIG. 2, the intermediate cylinder 14 has arranged therein an electrode connection portion to the positive electrode, and the inner cylinder 12 has arranged therein a first ground connection portion to the negative electrode (ground electrode). However, the following is permitted: the intermediate cylinder 14 has arranged therein the first ground connection portion to the negative electrode (ground electrode), and the inner cylinder 12 has arranged therein the electrode connection portion to the positive electrode. Similarly, the electrode connection portion to the positive electrode may be arranged in each of the inner cylinder 12 and the outer cylinder 13.

Meanwhile, when a flow path sectional area between the inner cylinder 12 and the intermediate cylinder 14, and that between the intermediate cylinder 14 and the outer cylinder 13 are compared to each other, the damping force generated at the time of the application of a voltage to the electro-rheological fluid is determined by an electrification amount (sectional area) between electrodes. Accordingly, when the electrodes are arranged so that a voltage may be applied between the inner cylinder 12 and the intermediate cylinder 14, the sectional area between the electrodes is small, and hence the same level of damping force (braking force) can be obtained with a smaller applied voltage, and by extension, a smaller current consumption. Further, even when the electrification amount increases owing to an increase in liquid temperature, a load to be applied to a power source is suppressed to a lower level by suppressing the electrification amount to a lower level. Thus, the overloading of the power source can be avoided. In addition, the ground may be the earth, or may be a frame ground, a signal ground, or the like. A current from the positive electrode only needs to be finally connected to a reference point of potential.

As described above, according to the present invention, in the electro-rheological fluid including the polyurethane particle(s), the reaction product of the mixture containing the chain extender in addition to the polyol, the isocyanate, and the emulsifying agent is adopted as the polyurethane particle(s). In addition, an increase in amount of the Li ion, that is, the ratio “[Li]/[O]” of the molar concentration ([Li]) of the Li ion to the molar concentration ([O]) of oxygen of the ether groups in the particle(s) is set to a certain value or more. Accordingly, the ratio at which each of an ER effect and a damping force is increased by the increase in amount of the Li ion can be increased.

In addition, the use of the above-mentioned chain extender and the increase in amount of the Li ion are combined, and hence an increase in current density due to the increase in amount of the Li ion is suppressed. Accordingly, coupled with the foregoing effect, the ER effect can be selectively improved without any increase in current density.

With such selective improvement in ER effect, in the cylinder device using the fluid such as a damper, a reduction in power consumption by the suppression of a current amount can be achieved while a damping characteristic is maintained.

### EXAMPLES

Next, the present invention is described in more detail by way of Examples. However, the present invention is not limited thereto.

Various electro-rheological fluids were prepared in accordance with the production flowchart of an electro-rheological fluid illustrated in FIG. 1.

Lithium chloride (lithium ion) and zinc chloride (zinc ion) were used as raw materials for metal ions, and a polyol solution (polyol: Polyol 3165 manufactured by Perstorp, number of functional groups: 3) having dissolved therein the raw materials, a catalyst for polyurethane synthesis (DABCO), and a chain extender (1,6-hexanediol (1,6-HD) (manufactured by Tokyo Chemical Industry Co., Ltd.)) was produced.

Polyol solutions were produced while various adjustments were performed so that in each of electro-rheological fluids to be finally obtained, the ratio “[Li]/[O]” of the molar concentration [Li] of the Li ion to the molar concentration [O] of the oxygen atoms of ether groups in polyurethane particles became from 0.78×10⁻⁴ to 4.56×10⁻⁴. In addition, 1,6-hexanediol (1,64-D) was used in such an amount that the molar amount of the hydroxy groups of 1,6-HD accounted for 15 mol % of the total molar amount (100 mol %) of the hydroxy groups of the polyol and the hydroxy groups of 1,6-HD. Polyol solutions in each of which 1,6-HD was not used were also prepared as Reference Examples.

Meanwhile, an emulsifying agent (KF-862 manufactured by Shin-Etsu Chemical Co., Ltd.) was dissolved in a silicone oil (KF96-5cs manufactured by Shin-Etsu Chemical Co., Ltd.) to produce a silicone solution. The emulsifying agent was used in an amount of 1.5 mass % with respect to the silicone oil.

Predetermined amounts of each of the polyol solutions and the silicone solution were weighed, and were loaded into the container of a disperser. The concentrations, usage amounts, and the like of the respective solutions were variously adjusted so that the amount of the polyurethane particles in the electro-rheological fluid to be finally obtained became 50 mass %.

After that, as illustrated in the flowchart of FIG. 1, the polyol solution was dispersed in the silicone solution in an emulsification step.

Next, an amount corresponding to about 20% of the total amount of isocyanates [manufactured by Tosoh Corporation, mixture of toluene 2,4-diisocyanate (TDI) and polymeric diphenylmethane diisocyanate (p-MDI)] serving as curing agents were added to a system to precure the dispersed product. After that, the remaining curing agents whose amount corresponded to about 80% of the total amount were added in a main curing step.

The total amount of the curing agents to be added here was adjusted so that the molar ratio “(NCO groups)/(OH groups)” of the isocyanate groups (NCO groups) of the curing agents (isocyanates) to the hydroxy groups (OH groups) of the polyol became from t to 1.5.

After the completion of the main curing step, the resultant fluid was filtered with a filter having a mesh of 125 μm to complete an electro-rheological fluid.

A plurality of electro-rheological fluid prototypes variously prepared by changing the presence or absence of 1,6-HD serving as a chain extender and a Li ion amount are collectively shown in Table 1 together with test results to be described later.

In Table 1, the electro-rheological fluid according to the present invention is shown as each of Examples, the electro-rheological fluids in each of which 1,6-HD serving as a chain extender is not used are shown as Reference Examples, and the electro-rheological fluids each deviating from, in particular, a condition range of [Li]/[O]≥9.0×10⁻⁵ in the present invention are shown as Comparative Examples. In the following description, the example numbers of the electro-rheological fluids are treated as the example numbers of the various test results to be described later.

### Test Example 1

The electro-rheological effects and current densities of the various electro-rheological fluids thus prepared were measured with a rheometer. The device, measurement conditions, and the like adopted in the measurement are described below.

### <Electro-Rheological Effect>

The storage modulus (G′) (Pa) of each of the resultant electro-rheological fluids at the time of voltage application was measured A value at a strain of 10% was evaluated as a representative value.
Measurement apparatus: Rheometer MCR302 (Anton Paar GmbH)
Jig: CC27
Measurement temperature: 30° C.
Applied voltage: 5 kV
Sample amount: 15 mL
Measurement program: strain dispersion measurement (frequency: 0.2 Hz)

### <Current Density>

The current density (μA/cm) of each of the resultant electro-rheological fluids at the time of voltage application was measured.
Measurement apparatus: Rheometer MCR302 (Anton Paar GmbH)
Jig: CC27
Measurement temperature: 30° C.
Applied voltage: 5 kV
Sample amount: 15 mL
Measurement program: strain dispersion measurement, current value 1 minute after start (frequency: 0.2 Hz)

The results of the measurement of the ER effect (storage modulus at a strain of 10%) and the current density (at 30° C.) are shown in Table 1. In addition, gradients obtained by linearly approximating the above-mentioned measured values with respect to the ratio “[Li]/[O]” of the molar concentration (I[Li]) of the Li ion to the molar concentration ([O]) of oxygen of the ether groups in each of the electro-rheological fluids of Examples 1 to 3 and Reference Examples 1 to 3 are shown together with the values.

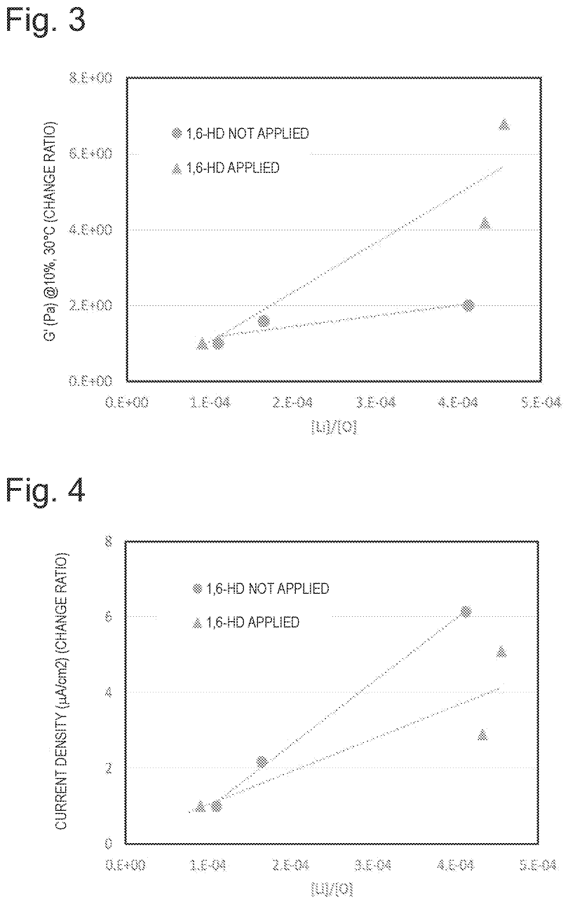

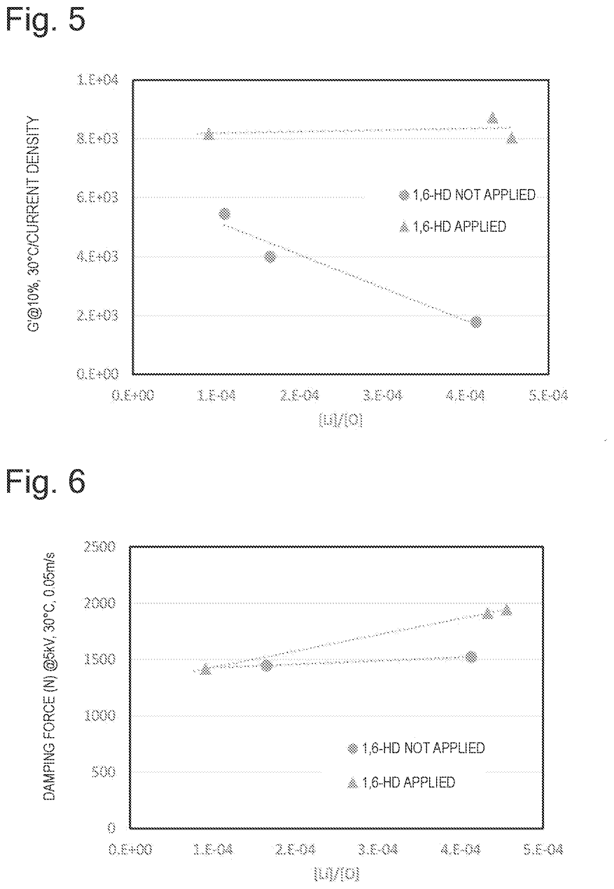

Further, the following values calculated on the basis of the measurement results of Examples 1 to 3 and Reference Examples 1 to 3 are shown in figures: the value (axis of ordinate) of the ER effect with respect to the ratio “[Li]/[O]” (axis of abscissa) is shown in FIG. 3; the value (axis of ordinate) of the current density at the time of the application of a voltage of 5 kV to the rheometer with respect to the ratio “[Li]/[O]” (axis of abscissa) is shown in FIG. 4; and the value (axis of ordinate) of the ratio “ER effect/current density” of the ER effect to the current density with respect to the ratio “[Li]/[O]” (axis of abscissa) is shown in FIG. 5.

In each of FIG. 3 to FIG. 5, the examples in each of which the chain extender (1,6-HD) is used are indicated by the symbol “♦” (Examples), and the examples in each of which the chain extender is not used are indicated by the symbol “●” (Reference Examples).

As shown in FIG. 3, irrespective of the presence or absence of the use of the chain extender (1,6-HD), a tendency that the ER effect increased along with an increase in ratio “[Li]/[O]” was observed. It was recognized that when the chain extender (1,6-HD) was applied (♦), the ratio at which the ER effect increased with the ratio “[Li]/[O]” became higher.

The result shows that the application of the chain extender makes the ratio at which the ER effect is increased by an increase in amount of the Li ion higher than that in the case where the extender is not applied.

As shown in FIG. 4, irrespective of the presence or absence of the use of the chain extender (1,64-D), a tendency that the current density value increased along with an increase in ratio “[Li]/[O]” was observed. However, it was recognized that when the chain extender (1,6-HD) was applied (♦), the ratio at which the current density increased with the ratio “[Li]/[O]” became lower.

The result shows that the application of the chain extender can suppress an increase in current density even when the amount of the Li ion increases.

The ratio (ER effect/current density) of the ER effect to the current density shown in FIG. 5 means that as the ratio becomes higher, the extent to which the ER effect is expressed on the current density becomes higher. Thus, it is grasped that efficient expression of the ER effect can be achieved.

As shown in FIG. 5, the following tendency was observed: when the chain extender (1,6-H-D) was not applied (θ), the ratio (ER effect/current density) of the ER effect reduced along with an increase in ratio “[Li]/[O]”; in contrast, when the chain extender (1,6-HD) was applied (♦), the ratio of the ER effect remained constant or slightly increased with an increase in ratio “[Li]/[O]”.

The result shows that the application of the chain extender can increase the ER effect while suppressing an increase in current density value to the extent possible.

### Test Example 2: Electro-Rheological Fluid Performance Test with Damper Real Machine

An electro-rheological fluid performance test was performed with the electro-rheological fluid damper 11 illustrated in FIG. 2.

The device and measurement conditions of a damper tester are as described below.
Measuring device: A vertical shaker (Tokyo Koki)
Amplitude kind: A sine wave
Frequency: 1 Hz
Amplitude: ±40 mm
Piston speed: 0.05 m/s or 0.9 n/s
Applied voltage: 5 kV
Temperature measurement: A sheath thermocouple K type
Measurement temperature: 30° C. or 50° C.

In an electro-rheological fluid damper system used in each of Examples, a power source of 50 W was used, and an upper limit current value was set to 10 mA for applying a maximum voltage of 5,000 V.

The ratio (damping force ratio) of a damping force at a measurement temperature of 50° C. to a damping force at a measurement temperature of 30° C. at the time of the application of a voltage of 5 kV and at a piston speed of 0.9 m/s is shown in Table 1.

FIG. 6 is a graph for showing a relationship between: the ratio [Li]/[O] (axis of abscissa) in an electro-rheological fluid used in the electro-rheological fluid damper; and the value (axis of ordinate) of a damping force (N) when a voltage of 5 kV is applied to the damper at a measurement temperature of 30° C. and a piston speed of 0.05 m/s. In FIG. 6, the examples in each of which the chain extender (1,6-HD) is used are indicated by the symbol “♦” (Examples), and the examples in each of which the chain extender is not used are indicated by the symbol “●” (Reference Examples).

As shown in FIG. 6, it was recognized that even in the case where the chain extender (1,6-HD) was applied (♦), the damper had a damping force enough for itself to function. In addition, the following result was obtained: the ratio at which the damping force increased with an increase in ratio “[Li]/[O]” became higher as compared to that in the case where 1,6-HD was not applied (●).

FIG. 7 is a graph for showing a relationship between: the ratio “[Li]/[O]” (axis of abscissa) in each of the electro-rheological fluids (Examples 1 to 4 and Comparative Examples 1 to 3) each using the chain extender; and the ratio (50° C./30° C.) (axis of ordinate) of a damping force at 50° C. to a damping force at 30° C. when a voltage of 5 kV is applied to the electro-rheological fluid damper using each of the fluids at a piston speed of 0.9 i/s.

As shown in FIG. 7 (and Table 1), when the ratio “[Li]/[O]” was equal to or more than a certain value (≥9.0×10⁻⁵), the damping force ratio (50° C./30° C.) was substantially constant, and the change ratio (reduction ratio) of the damping force at 50° C. with respect to the damping force at 30° C. was within 9%.

Meanwhile, when the ratio “[Li]/[O]” became equal to or less than 8.9×10⁻⁵ (Comparative Example 1 and Comparative Example 2), a tendency that the damping force ratio largely fluctuated, that is, the change ratio (reduction ratio) of the damping force at 50° C. with respect to the damping force at 30° C. abruptly increased was observed, with the result that the damping force at 50° C. reduced by as large as about 25% as compared to that at 30° C. Simultaneously, even in the damper after the test, the adhesion (sticking) of the particles to an electrode was remarkably observed (Comparative Example 1 and Comparative Example 2).

It was recognized from the foregoing results that a ratio “[Li]/[O]” of 9.0×10⁻⁵ or more was suitable as a range in which it was able to be judged that a fluctuation in damping force with temperature was absent, that is, a range in which a change in damping force due to a temperature change was less than 10%.

TABLE 1

| | | | Gradient of | | Gradient of | | Damping |
|---|---|---|---|---|---|---|---|
| | | | G′ with | Current | current density | G′/Current | force ratio |
| | | G′ at 10% | respect to | density | with respect to | density | (50° C./30° C., |
| | [Li]/[O] | (30° C.) | [Li]/[O] | (30° C.) | [Li]/[O] | [x10³ Pa/ | 0.9 m/s) |
| | (×10⁻⁴] | [×10³ Pa] | [×10⁴ Pa] | [μA/cm²] | [×10⁴ μA/cm²] | (μA/cm²)] | [—] |
| Example 1 | 4.33 | 2.53 | 1.3 | 0.29 | 0.87 | 8.72 | 0.91 |
| Example 2 | 4.56 | 4.12 | | 0.51 | | 8.04 | 0.91 |
| Example 3 | 0.91 | 0.74 | | 0.09 | | 8.17 | 0.97 |
| Example 4 | 0.9 | 0.97 | — | 0.11 | — | 8.82 | 0.93 |
| Reference | 1.1 | 1.96 | 0.28 | 0.36 | 1.67 | 5.44 | 0.99 |
| Example 1 | | | | | | | |
| Reference | 1.65 | 3.11 | | 0.78 | | 3.99 | 0.95 |
| Example 2 | | | | | | | |
| Reference | 4.13 | 3.92 | | 2.21 | | 1.77 | 0.82 |
| Example 3 | | | | | | | |
| Comparative | 0.89 | 4.21 | — | 0.56 | — | 7.5 | 0.77 |
| Example 1 | | | | | | | |
| Comparative | 0.78 | 1.71 | | 0.84 | | 2.04 | 0.77 |
| Example 2 | | | | | | | |

The present invention is not limited to the embodiments described above, and includes various modification examples. For example, in the embodiments described above, the configurations are described in detail in order to clearly describe the present invention, but the present invention is not necessarily limited to an embodiment that includes all the configurations that have been described. Further, a part of the configuration of a given embodiment may be replaced by the configuration of another embodiment, and the configuration of another embodiment may be added to the configuration of a given embodiment. Further, another configuration may be added to, deleted from, or replace a part of the configuration of each of the embodiments.

The present application claims priority based on Japanese Patent Application No. 2021-150468 filed on Sep. 15, 2021. All disclosed contents including Specification, Scope of Claims, Drawings, and Abstract of Japanese Patent Application No. 2021-150468 filed on Sep. 15, 2021 are incorporated herein by reference in their entirety.

### REFERENCE SIGNS LIST

11 ERF damper (electro-rheological fluid damper), 12 inner cylinder (cylinder), 13 outer cylinder, 20 piston, 23 piston rod, 14 intermediate cylinder (electrode)

1. An electro-rheological fluid, comprising:
a fluid having an insulating property; and
a polyether-based polyurethane particle comprising a metal ion,
wherein the polyurethane particle comprises a chain extender,
wherein the metal ion comprises at least a Li ion, and
wherein a ratio ([Li]/[O]) of a molar concentration ([Li]) of the Li ion to a molar concentration ([O]) of oxygen atoms of ether groups in the polyurethane particle satisfies the following condition.
[Ratio of molar concentration ([Li]) of Li ion to molar concentration ([O]) of oxygen of ether groups]
$$[ Li ] / [ O ] \geq 9.0 \times 1 {0}^{- 5}$$

2. The electro-rheological fluid according to claim 1, wherein the chain extender is an aliphatic diol.

3. The electro-rheological fluid according to claim 2, wherein the aliphatic diol is 1,6-hexanediol.

4. The electro-rheological fluid according to claim 1,
wherein the polyurethane particle comprises, as a constituent, a trifunctional polyether polyol having three hydroxy groups, and
wherein the polyurethane particle is formed of a thermosetting polyurethane resin.

5. The electro-rheological fluid according to claim 1,
wherein the polyurethane particle is a reaction product of a mixture comprising a polyether polyol, an isocyanate, an emulsifying agent, and the chain extender,
wherein the chain extender is a polyfunctional alcohol, and
wherein the chain extender is used in such an amount that a molar amount of hydroxy groups of the chain extender accounts for from 15 mol % to 25 mol % of a total amount (100 mol %) of a molar amount of hydroxy groups of the polyether polyol and the molar amount of the hydroxy groups of the chain extender.

6. A cylinder device, comprising:
a piston rod;
an inner cylinder into which the piston rod is inserted; and
an electro-rheological fluid arranged between the piston rod and the inner cylinder,
wherein the electro-rheological fluid is the electro-rheological fluid of claim 1.

7. A cylinder device, comprising:
a piston rod;
an inner cylinder into which the piston rod is inserted; and
an electro-rheological fluid arranged between the piston rod and the inner cylinder,
wherein the electro-rheological fluid comprises a fluid having an insulating property and a polyether-based polyurethane particle comprising a metal ion, the polyurethane particle comprises a chain extender, and the metal ion comprises at least a Li ion, and
wherein a change in damping force of the electro-rheological fluid due to a temperature change is less than 10%.

8. The electro-rheological fluid according to claim 2,
wherein the polyurethane particle comprises, as a constituent, a trifunctional polyether polyol having three hydroxy groups, and
wherein the polyurethane particle is formed of a thermosetting polyurethane resin.

9. The electro-rheological fluid according to claim 3,
wherein the polyurethane particle comprises, as a constituent, a trifunctional polyether polyol having three hydroxy groups, and
wherein the polyurethane particle is formed of a thermosetting polyurethane resin.

10. A cylinder device, comprising:
a piston rod;
an inner cylinder into which the piston rod is inserted; and
an electro-rheological fluid arranged between the piston rod and the inner cylinder,
wherein the electro-rheological fluid is the electro-rheological fluid of claim 2.

11. A cylinder device, comprising:
a piston rod;
an inner cylinder into which the piston rod is inserted; and
an electro-rheological fluid arranged between the piston rod and the inner cylinder,
wherein the electro-rheological fluid is the electro-rheological fluid of claim 3.

12. A cylinder device, comprising:
a piston rod;
an inner cylinder into which the piston rod is inserted; and
an electro-rheological fluid arranged between the piston rod and the inner cylinder,
wherein the electro-rheological fluid is the electro-rheological fluid of claim 4.

13. A cylinder device, comprising:
a piston rod;
an inner cylinder into which the piston rod is inserted; and
an electro-rheological fluid arranged between the piston rod and the inner cylinder,
wherein the electro-rheological fluid is the electro-rheological fluid of claim 5.

14. A cylinder device, comprising:
a piston rod;
an inner cylinder into which the piston rod is inserted; and
an electro-rheological fluid arranged between the piston rod and the inner cylinder,
wherein the electro-rheological fluid is the electro-rheological fluid of claim 8.

15. A cylinder device, comprising:
a piston rod;
an inner cylinder into which the piston rod is inserted; and
an electro-rheological fluid arranged between the piston rod and the inner cylinder,
wherein the electro-rheological fluid is the electro-rheological fluid of claim 9.
